(19) United States
(12) Patent Application Publication
(10) Pub. No.: US 2025/0100389 A1
(43) Pub. Date: Mar. 27, 2025

(54) SYSTEM FOR CONTROLLING A BRAKING OPERATION OF A VEHICLE

(71) Applicant: Volvo Truck Corporation, Göteborg (SE)

(72) Inventors: Hamid Yhr, Gråbo (SE); Leo Laine, Göteborg (SE); Ulf Stenbratt, Vallea (SE)

(21) Appl. No.: 18/833,992

(22) PCT Filed: Feb. 4, 2022
(86) PCT No.: PCT/EP2022/052720

§ 371 Date: Jul. 29, 2024

(51) Int. Cl. B60L 7/26

(52) U.S. Cl. CPC B60L 7/26; B60L 2240/26; B60L 2240/545; B60L 2240/547

(57) ABSTRACT

A system for controlling a braking operation of a vehicle, the system comprising an electric machine configured to apply a torque during propulsion, and to generate electric power during braking, an eddy current wheel brake connectable to a wheel of the vehicle, the eddy current wheel brake being electrically connected to the electric machine, and a control unit comprising control circuitry configured to receive a signal indicative of a demanded braking operation for the vehicle, determine a brake power state for the vehicle based on the demanded braking operation, compare the brake power state with a predetermined set of rules, control the electric machine to generate electric power, and control the electric machine to feed electric power, generated during the demanded braking operation, to the eddy current wheel brake when the brake power state fails to fulfil at least one rule of the predetermined set of rules.

### TECHNICAL FIELD

The present invention relates to a system for controlling a braking operation of a vehicle. The invention also relates to a method of controlling a braking operation of a vehicle. Although the invention will mainly be directed to a vehicle in the form of a truck, the invention may also be applicable for other types of vehicles comprising one or more electric machines for generating propulsion power, such as e.g., buses, working machines, trailers, and other transportation vehicles.

### BACKGROUND

A heavy-duty vehicle, such as a truck or semi-trailer vehicle, normally comprises a service brake system based on friction brakes. Friction brakes, such as disc brakes or drum brakes, are highly efficient in generating braking torque. However, if the friction brakes are used too intensively, a phenomenon referred to as brake fading may occur, which is why friction brakes are not suitable for prolonged periods of use that may, e.g., occur when driving downhill for an extended period of time. Brake fading is caused by a build-up of heat in the braking surfaces and leads to significantly reduced braking capability. To avoid brake fading, heavy-duty vehicles often comprise auxiliary brakes capable of endurance braking, such as engine brakes and various retarder systems.

Electric machines can also be used to brake a vehicle. The electric machine may then act as a generator which converts the kinetic energy from the vehicle into electrical energy. This electrical energy can be fed to an energy storage system (ESS) such as a rechargeable battery or the like, resulting in an overall increase in energy efficiency of the vehicle. Surplus energy from regenerative braking can be fed to a brake resistor where it is converted into heat.

Electric machines do not suffer from brake fading, but since the combined energy absorption capability of the ESS and any brake resistors is limited, the electric machine may still not be able to perform endurance braking for prolonged periods of time. Thus, either additional means for braking need to be installed in the vehicle, or the requirements on the electrical energy system of the vehicle must be over-dimensioned to support endurance braking, which is undesired.

### SUMMARY

It is thus an object of the present invention to at least partially overcome the above described deficiencies.

According to a first aspect, there is provided a system for controlling a braking operation of a vehicle, the system comprising an electric machine configured to apply a torque during propulsion, and to generate electric power during braking, an eddy current wheel brake connectable to a wheel of the vehicle, the eddy current wheel brake being electrically connected to the electric machine, and a control unit comprising control circuitry configured to receive a signal indicative of a demanded braking operation for the vehicle, determine a brake power state for the vehicle based on the demanded braking operation, compare the brake power state with a predetermined set of rules, control the electric machine to generate electric power, and control the electric machine to feed electric power, generated during the demanded braking operation, to the eddy current wheel brake when the brake power state fails to fulfil at least one rule of the predetermined set of rules.

During operation of the vehicle the control unit receives a signal of a braking demand, i.e. the demanded braking operation. The signal may be received from an autonomous vehicle propulsion system, or from a manually operated braking action. The brake power state is a state for the vehicle caused by the demanded braking operating. As will be described in further detail below, the brake power state may be a level of electric power generated by the electric machine for obtaining the demanded braking operation, i.e. the level of electric power generated by the electric machine to obtain a desired braking operation is based on the demanded braking operation. As an alternative, an as will also be described in further detail below, the brake power state may be a brake power level for the wheel connectable to the eddy current wheel brake, i.e. the brake power for a specific wheel is based on the demanded braking operation to obtain a desired braking operation.

Further, the predetermined set of rules should be construed as rules, where each rule is associated with a specific brake power state. As a non-limiting example, when the brake power state is the above described level of electric power generated by the electric machine for obtaining the demanded braking operation, at least one rule of the predetermined set of rules preferably relates to an electric power absorption capability of an energy storage system, i.e. how much electric power and/or at which ratio the energy storage system is able to absorb.

The present invention is based on the insight that it is beneficial to feed electric power, generated by the electric machine during braking, from the electric machine to the eddy current wheel brake at various brake power states. In particular, when the brake power state fails to fulfil at least one rule of the predetermined set of rules, this is an indicator that the electric machine should feed the generated electric power in a different manner compared to conventional regenerative braking where the electric power is solely supplied to the energy storage system for charging thereof. An advantage of the present invention is thus that electric power can be efficiently dissipated and simultaneously used by the eddy current wheel brake for providing a braking action of the wheel. As a non-limiting example, the electric power may be supplied to the eddy current wheel brake when there is a desire to increase the brake power level of a specific wheel of the vehicle, by using the electric machine as well as the eddy current wheel brake for obtaining the desired wheel brake power. Hence, when generating electric power by the electric machine and feed the electric power to the eddy current wheel brake, an amplification and superposition of the total brake power on the wheel can be improved. Electric power may also be efficiently dissipated to the eddy current wheel brake when the energy storage system for some reason is unable to absorb the electric power generated by the electric machine.

Further, when obtaining a peak braking torque from the electric machine for a short period of time, the generated electric power can be fed to the eddy current wheel brake which amplifies the total brake power for the wheel of the vehicle, thereby obtaining a solution that can replace conventional friction brakes also for so called “hard emergency braking”.

The use of an eddy current wheel brake is that such a brake is substantially maintenance free, i.e. it is not in need of maintenance in such a manner as e.g. a wheel brake using friction brake pads in need of continuous replacement.

According to an example embodiment, the brake power state may be a brake power demand level for the wheel connectable to the eddy current wheel brake, and wherein the brake power demand level fails to fulfil the at least one rule when brake power generated by the electric machine for the demanded braking operation is below the brake power demand level.

The overall brake demand for the vehicle may thus preferably be distributed for each wheel to obtain the demanded braking operation. The brake power demand level for the wheel connectable to the eddy current wheel brake should thus be construed as the portion of the overall brake power that is/should be distributed to the specific wheel connected to the eddy current wheel brake. When the electric machine is connected to a single wheel, such as a wheel hub motor, the brake power generated by electric machine is comparable to the brake power demand. When one electric machine is connected to a plurality of wheels, it is determined how much brake power being applied to the wheel connectable to the eddy current brake, i.e. how the electric machine distributes braking to the wheels.

When the brake power demand level fails to fulfil the at least one rule, the electric machine is unable to generate sufficient brake power to the wheel. An advantage is thus that the electric machine and the eddy current wheel brake in conjunction generates the brake power to the wheel, where the eddy current wheel brake is operated by electric power generated by the electric machine during the braking operation. An energy efficient power dissipation is hereby obtained. The brake power level on the wheel is thus amplified compared to braking solely using the electric machine.

According to an example embodiment, the electric machine may be connectable to an energy storage system of the vehicle, the brake power state being an electric power absorption capability of the energy storage system, wherein the electric power absorption capability fails to fulfil the at least one rule when a level of electric power generated by the electric machine during the braking operation is higher than the electric power absorption capability of the energy storage system.

The level of electric power generated by the electric machine may be either the amount of generated electric power or the ratio of generated electric power, i.e. the amount of generated electric power per time unit. The electric power absorption capability of the energy storage system thus relates to the level of electric power the electric power system is able to receive and/or the amount of generated electric power per time unit the electric power system is able to receive.

An advantage is thus that if the energy storage system is unable to receive the electric power, or portions of the electric power, generated by the electric machine, at least a portion of the generated electric power can be dissipated by feeding electric power to the eddy current wheel brake. Put it differently, regenerative braking can be obtained despite the energy storage system being unable to absorb the electric power generated during braking using the electric machine.

Accordingly, and according to an example embodiment, the control circuitry may be configured to determine the electric power absorption capability based on a current state of charge (SoC) of the energy storage system. Should the energy storage system be “full”, i.e. not able to receive further electric power, the electric power absorption capability of the energy storage system is low. Also, should the energy storage system not be in need of receiving electric power for any other reason, the electric power absorption capability of the energy storage system is also low.

According to an example embodiment, the control circuitry may be configured to determine the electric power absorption capability based on a current temperature level of the energy storage system. The electric absorption capability may thus vary depending on the temperature of the energy storage system. Should the electric absorption capability be reduced, at least a portion of the electric power generated by the electric machine during braking can be fed to the eddy current wheel brake, whereby the desired brake torque can be obtained using the electric machine in combination with the eddy current wheel brake. Also, the electric power absorption capability may also be based on a current state of health (SoH) of the energy storage system.

According to an example embodiment, the eddy current wheel brake may be electrically connectable to the energy storage system.

Hereby, the eddy current wheel brake can receive electric power for its operation from the energy storage system as well as from the electric machine which is advantageous during energy management of a vehicle energy system.

According to an example embodiment, the electric machine may be configured to apply a torque to a single wheel of the vehicle.

The electric machine may hereby be arranged as a so-called wheel hub motor. An advantage is that propulsion and braking can be individually controlled for the wheels of the vehicle.

According to an example embodiment, the eddy current wheel brake may comprise a conductive plate operatively connectable to a wheel axle of the wheel, and an electromagnet arranged stationary relative to the conductive plate.

According to an example embodiment, the eddy current wheel brake may comprise a plurality of conductive plates. Using more than one conductive plate can enable for an increased braking capability of the eddy current wheel brake.

According to an example embodiment, the control circuitry may be further configured to receive a signal indicative of a deceleration request of the vehicle, and determine the level of electric power generated by the electric machine during the braking operation based on the deceleration request. The deceleration request can be received from a manually operable braking action or from an autonomously controlled braking system.

According to an example embodiment, the control circuitry may be further configured to determine a current weight of the vehicle, and determine the level of electric power generated by the electric machine during braking operation based on the current weight.

According to an example embodiment, the control unit may form part of an upper layer vehicle motion control system, and wherein the electric machine comprises an electric machine control unit connected to the upper layer vehicle motion control system, the control circuitry being configured to control the electric machine by transmitting a signal to the electric machine control unit, the signal represents instructions which, when executed by the electric machine control unit, cause the electric machine to feed electric power to the eddy current wheel brake when the brake power state fails to fulfil at least one rule of the predetermined set of rules.

According to an example embodiment, the upper layer vehicle motion control system may be configured to control each of the plurality of electric machines independently from the other electric machines.

An advantage is that the upper layer vehicle motion control system can coordinate the braking action between the various electric machines and eddy current wheel brakes for obtaining the desired brake during the demanded braking operation.

According to an example embodiment, each of the plurality of eddy current wheel brakes may be electrically connected to each of the plurality of electric machines.

According to an example embodiment, the upper layer vehicle motion control system may be configured to control an electric machine of a first wheel to feed electric power to an eddy current wheel brake of a second wheel.

Hereby, a brake blending operation of the vehicle can be obtained. For example, an electric machine connected to a front left wheel can generate electric power during braking and feed the electric power to an eddy current wheel brake of a rear left wheel. In this example, braking on the left side is performed by an electric machine on the front left wheel and by an eddy current wheel brake on the rear left wheel.

According to a second aspect, there is provided a method of controlling a braking operation of a vehicle, the vehicle comprising a system, wherein the system comprises an electric machine configured to apply a torque during propulsion, and to generate electric power during braking, and an eddy current wheel brake connected to a wheel of the vehicle, the eddy current wheel brake being electrically connected to the electric machine, wherein the method comprises determining a brake power state for the vehicle based on a demanded braking operation, comparing the brake power state with a predetermined set of rules, controlling the electric machine to generate electric power, and controlling the electric machine to feed electric power, generated during the demanded braking operation, to the eddy current wheel brake when the brake power state fails to fulfil at least one rule of the predetermined set of rules.

Effects and features of the second aspect are largely analogous to those described above in relation to the first aspect. Thus, features described in relation to the first aspect are equally applicable to the second aspect.

According to a third aspect, there is provided a vehicle, comprising a system according to any one of embodiments described above in relation to the first aspect.

According to a fourth aspect, there is provided a computer program comprising program code means for performing the steps of the second aspect when the program is run on a computer.

According to a fifth aspect, there is provided a computer readable medium carrying a computer program comprising program means for performing the steps of the second aspect when the program means is run on a computer.

Effects and features of the third, fourth and fifth aspects are largely analogous to those described above in relation to the first aspect.

Further features of, and advantages will become apparent when studying the appended claims and the following description. The skilled person will realize that different features may be combined to create embodiments other than those described in the following, without departing from the scope of the present disclosure.

### BRIEF DESCRIPTION OF THE DRAWINGS

The above, as well as additional objects, features, and advantages, will be better understood through the following illustrative and non-limiting detailed description of exemplary embodiments, wherein:

FIG. 1 is a lateral side view illustrating an example embodiment of a vehicle in the form of a truck;

FIG. 2 illustrates a braking system according to an example embodiment;

FIG. 3 illustrates an eddy current wheel brake according to an example embodiment;

FIG. 4 illustrates control modules for operating the braking system according to an example embodiment; and

FIG. 5 is a flow chart of a method of controlling a braking system according to an example embodiment.

### DETAILED DESCRIPTION

The present invention will now be described more fully hereinafter with reference to the accompanying drawings, in which exemplary embodiments are shown. The invention may, however, be embodied in many different forms and should not be construed as limited to the embodiments set forth herein; rather, these embodiments are provided for thoroughness and completeness. Like reference character refer to like elements throughout the description.

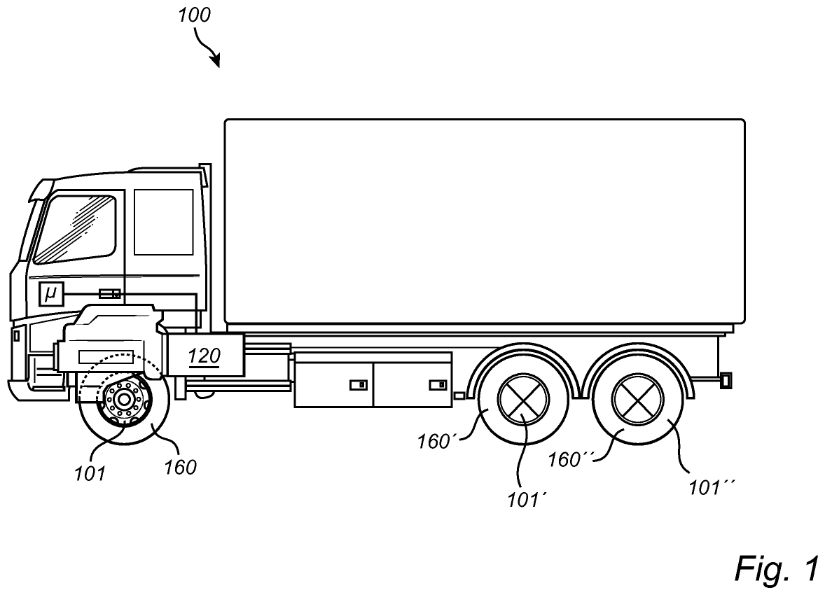

With particular reference to FIG. 1, there is provided a vehicle 1 in the form of a heavy-duty truck for cargo transport. However, a heavy-duty vehicle could also be a vehicle designed for use in construction, mining operations, and the like. It is appreciated that the techniques and devices disclosed herein can be applied together with a wide variety of electrically powered vehicle units, not just that exemplified in FIG. 1. In particular, the techniques disclosed herein are also applicable to, e.g., rigid trucks and multi-trailer electric heavy-duty vehicles comprising one or more dolly vehicle units, etc.

The vehicle 100 is an electrically powered vehicle comprising one or more electric machines 101, 101′, 101″. As can be seen in FIG. 1, the exemplified heavy-duty vehicle comprises an electric machine connected to the front steerable wheels 160, the foremost pair of rear wheels 160′ and the rearmost pair of rear wheels 160″. The one or more electric machines are arranged to generate both positive and negative torque, i.e., to provide both propulsion and braking of the vehicle 100. The vehicle 100 also comprises an energy storage system 120 configured to power the one or more electric machines. The energy storage system 120 may comprise a battery pack and potentially also a fuel cell stack arranged to generate electrical energy from a hydrogen storage tank on the vehicle 100 (not shown in FIG. 1). The energy storage system optionally also comprises a brake resistance arranged to dissipate surplus energy which the electrical energy storage devices on the vehicle cannot accommodate.

A vehicle control unit 130 is arranged to monitor and control various vehicle operations and functions. The vehicle control unit is, e.g., arranged to monitor and control the energy storage system 120 as well as the one or more electric machines 101, 101′, 101″, and optionally also the operation of the fuel cell stack. The vehicle control unit 130 may also comprise, or form part of a higher layer vehicle motion control system comprising control functions such as vehicle route planning and may have access to geographical data comprising height profiles of different planned vehicle routes and the like, as well as positioning data indicating a current location of the vehicle 100.

The vehicle 100 optionally comprises a wireless communications transceiver arranged to establish a radio link to a wireless network comprising a remote server.

This way the control unit may access the remote servers for uploading and downloading data. Notably, the vehicle 100 may store measurement data such as amounts of regenerated energy by the one or more electric machines 101, 101′, 101″ at various geographical locations an along different vehicle routes in local memory or at the remote server. The vehicle control unit 130 may also query the remote server for information about previously experienced amounts of regenerated energy, and/or temperature increases in various vehicle components along a given route.

The vehicle control unit 130 may furthermore be arranged to obtain data indicative of an expected rolling resistance for a given route, either from manual configuration or remotely from the remote server. The rolling resistance of the vehicle 100 will affect the energy consumption of the vehicle as it traverses a route. For instance, a gravel road is likely to require more energy compared to a smoother asphalt freeway. Also, friction and air resistance will reduce the requirements on generating negative torque during downhill driving.

It is required to be able to brake the vehicle 100 as it travels down steep long hills and the like. The electric machines 101, 101′, 101″ on the vehicle 100 may, as mentioned above, be used to generate braking torque. Electrical energy from the electric machines generated during braking can then be fed to the energy storage system as long as the energy storage system can absorb the power, resulting in recuperated energy and a more energy efficient vehicle operation, which is an advantage. However, when the batteries of the energy storage system are fully charged, no more energy can be absorbed. Furthermore, there may be a limit on maximum current or voltage that can be fed to the batteries of the energy storage system when charging, i.e. the energy storage system may have a maximum electric power absorption capability. If the batteries in the energy storage system cannot accept all of the output energy from the electric machines, surplus energy can be fed to the brake resistor which then dissipates the surplus energy as heat. However, a brake resistor also has a maximum amount of power it can absorb since it will eventually get too hot. Furthermore, there is normally a peak power capability of the brake resistor, i.e., there may be a limit on maximum current or voltage that can be fed to the brake resistor. Also, the electric machines may not at all operating conditions be able to generate the brake power level required for obtaining the desired braking operation.

If the battery on the vehicle 100 is fully charged and if the brake resistor has reached a maximum allowable temperature, there is no safe way of dispersing the power generated from the electric machine during braking. This problem can be alleviated somewhat by over-dimensioning the brake resistor, but this solution is not desired since it drives cost and component complexity.

An electrical motor is normally operated at maximum efficiency, meaning that maximum output power is generated during regenerative braking in order to recuperate as much energy as possible during downhill driving. However, it has been realized that there is a control freedom associated with electric machines which allow most electric machines to be operated at a reduced efficiency. An electric machine used to generate braking torque which is operated in a less energy efficient mode of operation will generate more heat and less output current compared to an electric machine that is operated at maximum efficiency.

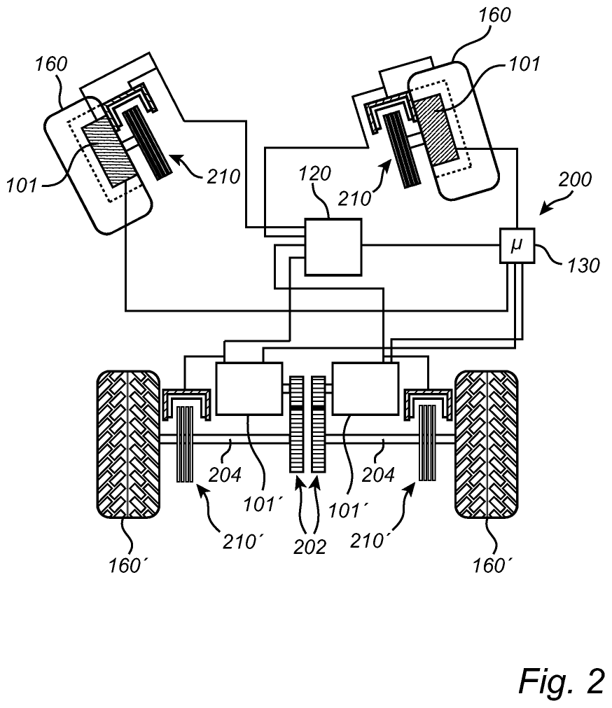

Turning to FIG. 2 which is a system 200 for controlling a braking operation of the heavy-duty vehicle 100 according to an example embodiment. The heavy-duty vehicle in Fig. is illustrated as comprising the front steerable wheels 160 and the frontmost rear wheel 160′. It should however be readily understood that the following description applies to a heavy-duty vehicle comprising further pair of wheels, such as e.g. the vehicle depicted in FIG. 1. The front steerable wheels 160 will in the following simply be referred to as the front wheels 160, and the frontmost rear wheels 160′ will in the following be referred to as the rear wheels 160′.

The system 200 comprises the above described control unit 130. The control unit 130 may include a microprocessor, microcontroller, programmable digital signal processor or another programmable device. The control unit 130 may also, or instead, include an application specific integrated control circuit, a programmable gate array or programmable array logic, a programmable logic device, or a digital signal processor. Where the control unit 130 includes a programmable device such as the microprocessor, microcontroller or programmable digital signal processor mentioned above, the processor may further include computer executable code that controls operation of the programmable device.

Furthermore, the system 200 comprises a plurality of electric machines 101, 101′ which, as described above, are each configured to apply a torque during propulsion, and to generate electric power during braking. The electric machines 101 connected to the front wheels 160 are exemplified as a respective wheel hub motor, while the electric machines 101′ are each connected to the respective rear wheels 160′ via a gear wheel arrangement 202 and a wheel axle 204. The electric machines 101 connected to the front wheels 160 and the electric machines 101′ connected to the rear wheels 160′ thus apply a torque to the wheels during propulsion and generate electric power during braking but in a somewhat different manner. The electric machines 101, 101′ are each electrically connected to the energy storage system 120. The electric machines 101, 101′ as well as the energy storage system 120 are also electrically connected to the control unit 130.

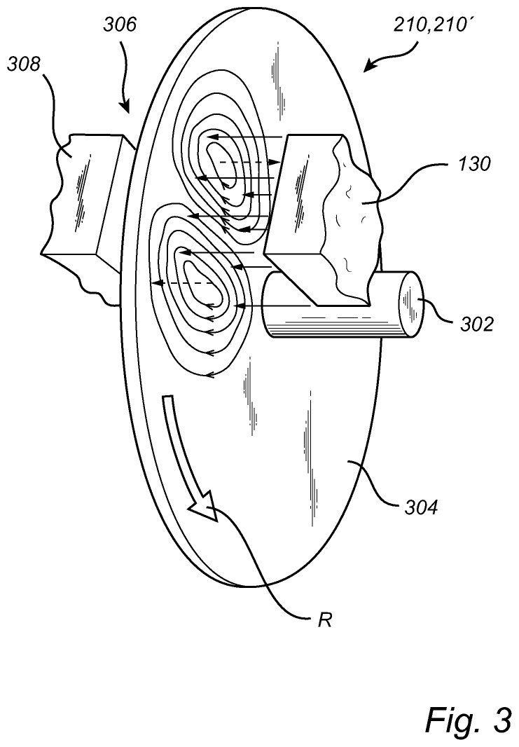

The wheel brakes of the system are formed by eddy current wheel brakes 210, 210′. Details of the eddy current wheels brakes 210, 210′ will be given below in relation to the description of FIG. 3. Each one of the eddy current wheel brakes 210, 210′ is connected to a respective wheel 160, 160′ of the heavy-duty vehicle 100. As can be seen, each eddy current wheel brake 210, 210′ is electrically connected to a respective electric machine 101, 101′. In particular, and for example, the eddy current wheel brake 210′ of the left rear wheel 160′ is electrically connected to the electric machine 101′ connected to the left rear wheel 160′. The eddy current wheel brake 210′ of the left rear wheel 160′ may also, via the energy storage system 120, be electrically connected to another electric machine of the heavy-duty vehicle 100 such as e.g. the electric machine 101 connected to the right front wheel 160, etc. The eddy current wheel brakes 210, 210′ are thus also electrically connected to the energy storage system 120.

As will also be described in further detail below, each of the eddy current wheel brakes 210, 210′ is arranged to generate a brake torque on the wheel it is connected to. The brake torque is applied when the eddy current wheel brake 210, 210′ is fed with electric power. As described above, the eddy current wheel brake 210, 210′ is electrically connected to at least one of the electric machines 101, 101′. Hereby, during braking when the electric machine generates electric power, the electric machine 101, 101′ can be controlled by the control unit 130 to feed the electric power to the eddy current wheel brake 210, 210′ such that the eddy current wheel brake 210, 210′ applies a brake torque on the wheel it is connected to. The electric machine 101, 101′ may also be controlled to feed a portion of the generated electric power to the eddy current wheel brake 210, 210′, and another portion of the generated electric power to the energy storage system 120. As a further option, the electric machine 101, 101′ may be controlled to feed all the generated electric power to the energy storage system 120.

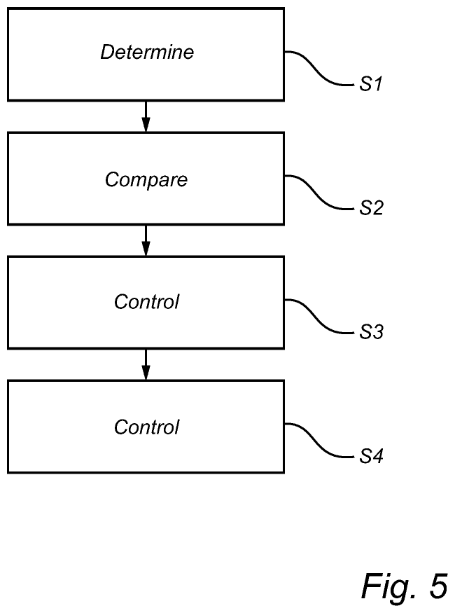

During operation, and with reference to FIG. 2 in combination with FIG. 5, of the system 200 according to the present invention, the control unit 130 receives a signal indicative of a demanded braking operation for the heavy-duty vehicle 100. The demanded braking operation may thus relate to a desired reduction of the current vehicle speed, or the brake power needed to maintain a desired vehicle speed when e.g. driving in a downhill slope. Based on the demanded braking operation, a brake power state is determined S1. The brake power state may for example be a desired level of brake power, i.e. a brake power demand level for a wheel of the vehicle 100, to obtain the desired reduction of vehicle speed. The brake power state may also be an electric absorption capability of the energy storage system, i.e. how much electric power the energy storage system is able to absorb, and/or at which electric power rate (i.e. per time unit) the energy storage system is able to absorb.

The electric absorption capability of the energy storage system is likely to vary over time, and can be monitored by the control unit 130, e.g., by determining a state of charge (SoC) of a battery pack comprised in the energy storage system 120, by determining a temperature of the battery pack comprised in the energy storage system 120, and/or determining a temperature of a brake resistor comprised in the energy storage system 120. The relationship between electric absorption capability and these different parameters can be pre-configured at the factory when the vehicle 100 is assembled, e.g., as a look-up table or the like in a memory accessible from the control unit 130, and/or regularly provided as part of a software update. Electric absorption capability in terms of power may be limited by an upper power limit which depends on the design of the energy storage system, i.e., the rating of the components comprised in the energy storage system. The capability of the energy storage system in terms of power is normally also dependent on temperature. For instance, brake resistance temperature impacts electric absorption capability negatively, since a very hot braking resistance may not be able to absorb very much energy until it has cooled down again. The electric absorption capability in terms of energy amount is often a linear function of state of charge, where a nearly fully charged battery pack cannot absorb so much electric energy, and a nearly empty battery pack is able to absorb a significant amount of electric energy.

The determined brake power state is compared S3 with a predetermined set of rules. Each rule of the predetermined set of rules is associated with a specific type of brake power state. For example, if the brake power state is the above described brake power demand level for a wheel of the vehicle 100, the predetermined rule is preferably a predetermined threshold brake power level. According to another example, if the brake power state is the above described electric absorption capability of the energy storage system 120, the predetermined rule is preferably an electric absorption capability threshold for the energy storage system 120.

During the braking operation, the electric machine 101, 101′ is controlled S4 to generate electric power. During the braking operation, the electric machine 101, 101′ is also controlled S5, by receiving a signal from the control unit 130, to feed generated electric power to the eddy current wheel brake 210, 210′ when the above described brake power state fails to fulfil at least one rule of the predetermined set of rules. To put it differently, and as an example, the electric machine 101, 101′ is controlled to feed at least a portion of the generated electric power to the eddy current wheel brake 210, 210′ when the electric machine 101, 101′ is unable to solely provide the desired brake torque to the wheel 160, 160′ of the vehicle 100.

Hereby, the electric machine 101, 101′ and the eddy current wheel brake 210, 210′ in conjunction apply a brake torque on the wheel 160, 160′ of the vehicle 100. According to another example, the electric machine 101, 101′ is controlled to feed at least a portion of the generated electric power to the eddy current wheel brake 210, 210′ when the energy storage system 120 is unable, for some reason, to absorb the electric power generated by the electric machine 101, 101′ during the braking operation.

Accordingly, the control unit 130 may be arranged to determine a level of electric power generated by the electric machine during braking, determine an electric power absorption capability of the energy storage system of the heavy-duty electric vehicle, and control the electric machine to supply electric power, generated during braking, to the electromagnetic brake when the level of electric power generated by the electric machine is higher than the electric power absorption capability of the energy storage system.

In order to describe the eddy current wheel brake in further detail, reference is made to FIG. 3 which illustrates the eddy current wheel brake 210, 210′ according to an example embodiment. The eddy current wheel brake 210, 210′ comprises a conductive plate 304, i.e. a conductive disc. The conductive plate 304 is fixedly attached to a wheel shaft 302 and thus rotates R along with the rotation of the wheel 160, 160′. Further, the eddy current wheel brake 210, 210′ also comprises an electromagnet 306 configured to receive electric power from the above described electric machine, and/or from the energy storage system 120 depending on the current brake power state. The electromagnet 306 comprises a north magnetic pole 308 and a south magnetic pole 310, where the north and south magnetic poles are arranged on a respective side of the conductive plate 304 and at a distance from the conductive plate 304. The electromagnet 306 is thus arranged stationary relative to the conductive plate 304.

When the conductive plate 304 moves past the stationary electromagnet, the electromagnet exerts a drag force on the metal which opposes its motion, due to circular electric currents, also referred to as eddy currents, induced in the metal by the magnetic field. Hereby, the rotational velocity of the conductive plate 304, and thus also the rotational velocity of the wheel shaft 302 and the wheel 160, 160′ is reduced. The conductive plate is preferably formed by a non-ferromagnetic metal such as e.g. copper or aluminium, which are not attracted to the electromagnet.

FIG. 3 illustrates the use of a single conductive plate 304. It should however be readily understood that if an increased brake capability of the eddy current wheel brake is desired, the eddy current wheel brake may be provided with a plurality of conductive plates between the north and south magnetic poles. In such configuration, the conductive plates are preferably arranged parallel with each other along the axial direction of the wheel shaft 302.

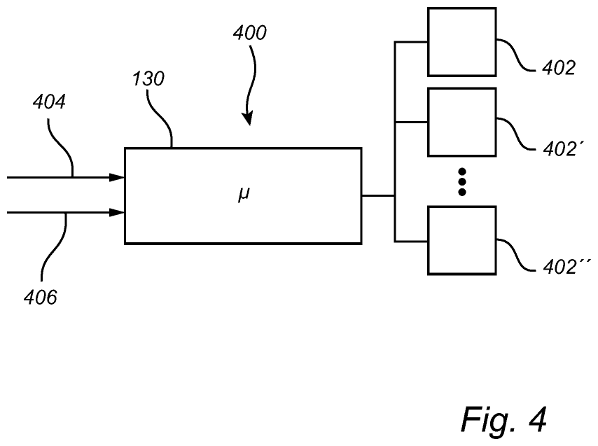

The above described control unit 130 may form part of an upper layer vehicle motion management control system 400. Reference is now made to FIG. 4 to describe control modules for operating the above described braking system according to an example embodiment. In the example embodiment, each of the above described electric machines 101, 101′ comprises a respective electric machine control unit 402, 402′, 402″ connected to the upper layer vehicle motion control system 400. The upper layer motion control system 400 can hereby control each of the plurality of electric machines independently from the other electric machines by transmitting a control signal to a specific electric machine control unit 402, 402′, 402″.

The upper layer vehicle motion control system 400 is arranged to receive the above described signal 404 indicative of a demanded braking operation. The signal 404 may, for example, be a deceleration request. The upper layer vehicle motion control system 400 may also receive a signal 406 indicative of a current electric absorption capability of the energy storage system. The upper layer vehicle motion control system 400 may also receive other types of signals, such as e.g. a current weight of the vehicle, etc.

When the upper layer vehicle motion control system 400 receives the signal(s), it determines the brake power state and transmits control signal(s) to the electric machine control unit 402, 402′, 402″ for controlling the electric machine(s) 101, 101′ according to the above disclosure.

It is to be understood that the present disclosure is not limited to the embodiments described above and illustrated in the drawings; rather, the skilled person will recognize that many changes and modifications may be made within the scope of the appended claims.

1. A system for controlling a braking operation of a vehicle, the system comprising:
an electric machine configured to apply a torque during propulsion, and to generate electric power during braking, wherein the electric machine is configured to apply a torque to a single wheel of the vehicle,
an eddy current wheel brake connectable to a wheel of the vehicle, the eddy current wheel brake being electrically connected to the electric machine, wherein the electric machine and the eddy current wheel brake are connectable to the same wheel of the vehicle, and
a control unit comprising control circuitry configured to:
receive a signal indicative of a demanded braking operation for the vehicle,
determine a brake power state for the vehicle based on the demanded braking operation,
compare the brake power state with a predetermined set of rules,
control the electric machine to generate electric power, and
control the electric machine to feed electric power, generated during the demanded braking operation, to the eddy current wheel brake when the brake power state fails to fulfil at least one rule of the predetermined set of rules.

2. The system of claim 1, wherein the brake power state is a brake power demand level for the wheel connectable to the eddy current wheel brake, and wherein the brake power demand level fails to fulfil the at least one rule when brake power generated by the electric machine for the demanded braking operation is below the brake power demand level.

3. The system of claim 1, wherein the electric machine is connectable to an energy storage system of the vehicle, the brake power state being an electric power absorption capability of the energy storage system, wherein the electric power absorption capability fails to fulfil the at least one rule when a level of electric power generated by the electric machine during the braking operation is higher than the electric power absorption capability of the energy storage system.

4. The system of claim 3, wherein the control circuitry is configured to determine the electric power absorption capability based on a current state of charge (SoC) of the energy storage system.

5. The system of claim 3, wherein the control circuitry is configured to determine the electric power absorption capability based on a current temperature level of the energy storage system.

6. The system of claim 3, wherein the eddy current wheel brake is electrically connectable to the energy storage system.

7. (canceled)

8. The system of claim 1, wherein the eddy current wheel brake comprises a conductive plate operatively connectable to a wheel axle of the wheel, and an electromagnet arranged stationary relative to the conductive plate.

9. The system of claim 8, wherein the eddy current wheel brake comprises a plurality of conductive plates.

10. The system of claim 1, wherein the control circuitry is further configured to:
receive a signal indicative of a deceleration request of the vehicle, and
determine the level of electric power generated by the electric machine during the braking operation based on the deceleration request.

11. The system of claim 1, wherein the control circuitry is further configured to:
determine a current weight of the vehicle, and
determine the level of electric power generated by the electric machine during braking operation based on the current weight.

12. The system of claim 1, wherein the control unit forms part of an upper layer vehicle motion control system, and wherein the electric machine comprises an electric machine control unit connected to the upper layer vehicle motion control system, the control circuitry being configured to control the electric machine by transmitting a signal to the electric machine control unit, the signal represents instructions which, when executed by the electric machine control unit, cause the electric machine to feed electric power to the eddy current wheel brake when the brake power state fails to fulfil at least one rule of the predetermined set of rules.

13. The system of claim 12, wherein the upper layer vehicle motion control system is configured to control each of the-a plurality of electric machines independently from the other electric machines.

14. The system of claim 13, wherein each of the plurality of eddy current wheel brakes is electrically connected to each of the plurality of electric machines.

15. The system of claim 14, wherein the upper layer vehicle motion control system is configured to control an electric machine of a first wheel to feed electric power to an eddy current wheel brake of a second wheel.

16. A method of controlling a braking operation of a vehicle, the vehicle comprising a system, wherein the system comprises:
an electric machine configured to apply a torque during propulsion, and to generate electric power during braking, wherein the electric machine is configured to apply a torque to a single wheel of the vehicle, and
an eddy current wheel brake connected to a wheel of the vehicle, the eddy current wheel brake being electrically connected to the electric machine, wherein the electric machine and the eddy current wheel brake are connectable to the same wheel of the vehicle, and
wherein the method comprises:
determining a brake power state for the vehicle based on a demanded braking operation,
comparing the brake power state with a predetermined set of rules,
controlling the electric machine to generate electric power, and
controlling the electric machine to feed electric power, generated during the demanded braking operation, to the eddy current wheel brake when the brake power state fails to fulfil at least one rule of the predetermined set of rules.

17. A vehicle, comprising the system of claim 1.

18. A computer program comprising program code means for performing the method of claim 16 when the program is run on a computer.

19. A computer readable medium carrying a computer program comprising program means for performing the method of claim 16 when the program means is run on a computer.
